(19) United States
(12) Patent Application Publication
(10) Pub. No.: US 2007/0168433 A1
(43) Pub. Date: Jul. 19, 2007

(54) System and method for managing an instant messaging contact list

(76) Inventor: Fabian F. Morgan, Austin, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/334,232

(22) Filed: Jan. 18, 2006

(51) Int. Cl. G06F 15/16

(52) U.S. Cl. 709/206

(57) ABSTRACT

A method and system for managing an instant messaging contact list. The method includes determining if at least one group member of the instant messaging contact list is active. A timestamp is assigned to the group member based on a determination of activity. It is determined whether the group member is inactive for a predetermined period of time. The instant messaging contact list is updated based on the determination of the inactivity.

### TECHNICAL FIELD OF THE INVENTION

The present invention relates generally to computer systems and in particular to the management of an instant messaging contact list.

### BACKGROUND OF THE INVENTION

Numerous users are using software that enables them to be alerted when friends, family, and colleagues go on-line for the real-time exchange of messages. A commonly used term for this type of real-time exchange is instant messaging (IM). IM is relatively inexpensive, with most vendors freely distributing the product and others charging nominal licensing fees. It is also a powerful technology, allowing users to communicate in one window while, for example, looking over a document in another. Team members in different locations can set up impromptu conversations, bouncing ideas and strategies off each other.

After a user establishes an account he/she can add or be invited to be added onto an IM contact list or “buddy list”. The IM contact list shows whether or not someone in your IM community is online at a particular time. As time passes, the IM contact list can grow to be very large in size. In the corporate setting, for example, a large volume of communication is achieved on an “as-need” basis for a short period of time with one or more counterparts. After the project has been completed or should one or more of the counterparts leave the company, those contacts can become obsolete. As such, the contact information can unnecessarily clog the buddy list.

Therefore, it would be desirable to provide a strategy for maintenance of instant messaging contact list that would overcome the aforementioned and other disadvantages.

### SUMMARY OF THE INVENTION

One aspect of the present invention provides a method of managing an instant messaging contact list. The method includes determining if at least one group member of the instant messaging contact list is active. A timestamp is assigned to the group member based on a determination of activity. It is determined whether the group member is inactive for a predetermined period of time. The instant messaging contact list is updated based on the timestamp and the determination of the inactivity.

Another aspect of the present invention provides a computer usable medium including a program for managing an instant messaging contact list. The medium includes computer readable program code for determining if at least one group member of the instant messaging contact list is active, and computer readable program code for assigning a timestamp to the group member based on the determination of activity. The medium further includes computer readable program code for determining whether the group member is inactive for a predetermined period of time; and computer readable program code for updating the instant messaging contact list based on the timestamp and the determination of the inactivity.

Another aspect of the present invention provides a system of managing an instant messaging contact list. The system includes means for determining if at least one group member of the instant messaging contact list is active, and means for assigning a timestamp to the group member based on the determination of activity. The system further includes means for determining whether the group member is inactive for a predetermined period of time; and means for updating the instant messaging contact list based on the timestamp and the determination of the inactivity.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof

### BRIEF DESCRIPTION OF THE DRAWINGS

FIG. 1 illustrates a system of managing an instant messaging contact list, in accordance with one embodiment of the present invention;

FIG. 2 illustrates an instant messaging contact list, in accordance with one embodiment of the present invention;

FIG. 3 illustrates a flow chart of a method of managing an instant messaging contact list, in accordance with one embodiment of the present invention;

FIG. 4 illustrates one embodiment of a method for assigning a timestamp in accordance with the invention;

FIG. 5 illustrates one embodiment of a method for updating instant messaging contact information in accordance with one aspect of the invention;

FIG. 6 illustrates one embodiment of a method for sending a user prompt in accordance with one aspect of the invention; and

FIG. 7 illustrates an updated instant messaging contact list in accordance with one aspect of the invention.

### DETAILED DESCRIPTION OF THE PRESENTLY PREFERRED EMBODIMENTS

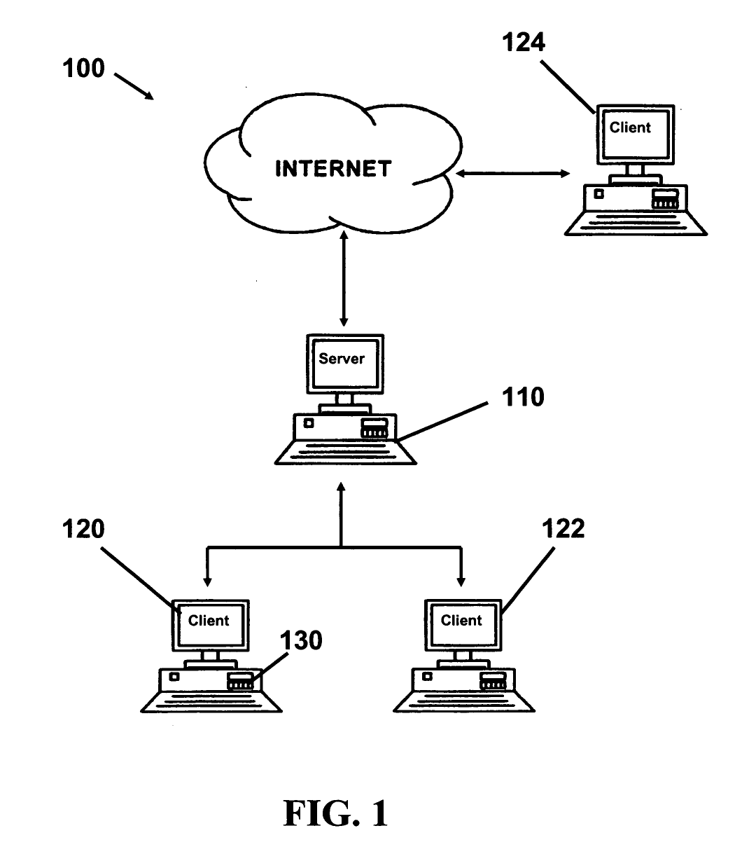

FIG. 1 illustrates a system for managing an instant messaging (IM) contact list, in accordance with one embodiment of the present invention, and shown generally by numeral 100. System 100 includes a server 110 linked to a plurality of client computers 120, 122, 124. Server 110 is electronically connected to the client computers 120, 122 forming a local area network (LAN). The server 110 is electronically connected to a remote client computer 124 through the Internet, thereby forming a wide area network (WAN). Those skilled in the art will appreciate that there are a myriad of types of computer connections and configurations that can be adapted for use with the present invention.

In one embodiment, the server 110 and client computers 120, 122, 124 include at least one storage disk 130. The storage disks 130 can be any type of storage devices capable of reading, writing, and storing data in the form of a database. For the purposes of this description, the term “disk” refers to any type of storage media including, but not limited to, magnetic disk drives (e.g. hard and floppy), optical drives (e.g. CDROM, CDR, CDR, DVD, DVDR, etc.), flash-type media, magnetic tape, holographic storage, paper tape, punched cards, and the like. In one embodiment, the storage disk stores IM contact information, such as an IM contact list.

In one embodiment, the server 110 runs an IM program. IM programs are software configured to allow substantially real-time communications, such as text, visual, audible, multimedia or file transfer, between at least two users of the program with minimal latency. In another or the same embodiment, one or more client computers 120, 122, 124 each run portions of the IM program (e.g., applets). At certain times of the IM program execution, actions and functions can be performed manually by a user (i.e., through mouse/keyboard/voice input at the server 110 and/or client computers 120, 122, 124) or automatically (i.e., through coding in the program). Client computers 120, 122, 124 can have one or more separate users. Client computers 120, 122, 124 maintain an IM contact list from which they can query and then exchange information with another computer in real-time. The IM contact list can be stored on a resident storage disk 130 of a given client computer 120, 122, 124 and/or a remote disk. In one embodiment, a user maintains his/her own specific IM contact list even if he/she shares a client computer 120, 122, 124 with others. In one embodiment, this specific IM contact list is available to the user each time the user ‘logs on’ to the IM system, regardless of the computer that the user is operating to use the IM system.

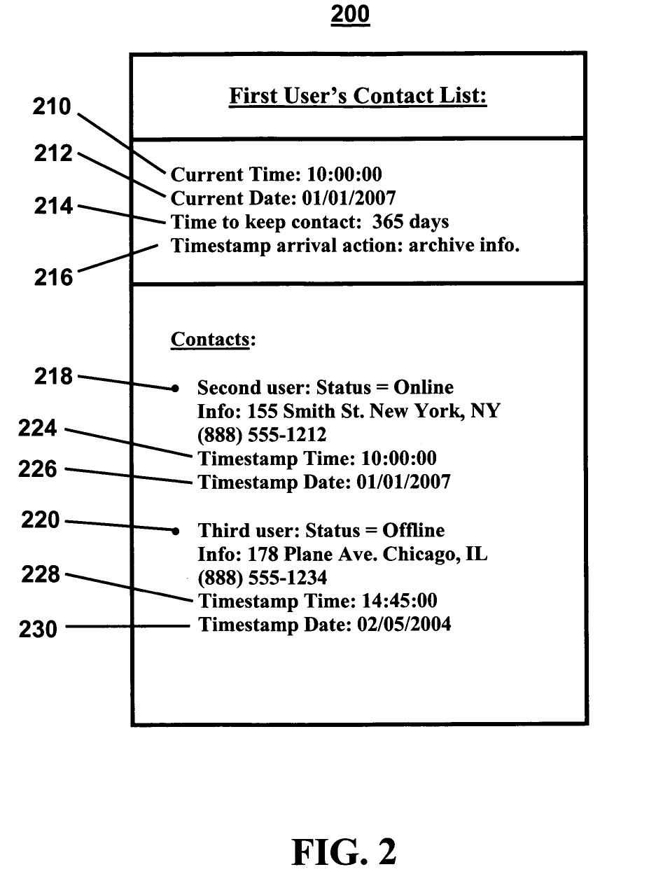

FIG. 2 illustrates an IM contact list 200, in accordance with one embodiment of the present invention. In one embodiment, IM contact list 200 includes the current time 210, current date, 212, a predetermined period of time 214, an action upon reaching the predetermined period of time 216, and contacts 218, 220. Each entry on the IM contact list includes, for example, address, phone, and timestamp time and date information. In one embodiment (discussed below), the user can change the action upon reaching the predetermined period of time 216. IM contact list 200 further includes first timestamp time 224 and first timestamp date 226 associated with second user 218 and second timestamp time 228 and second timestamp date 230 associated with third user 220. In other embodiments, the first and second timestamp time 224, 228 and first and second timestamp date 226, 230 are tracked as a single entry in IM contact list 200.

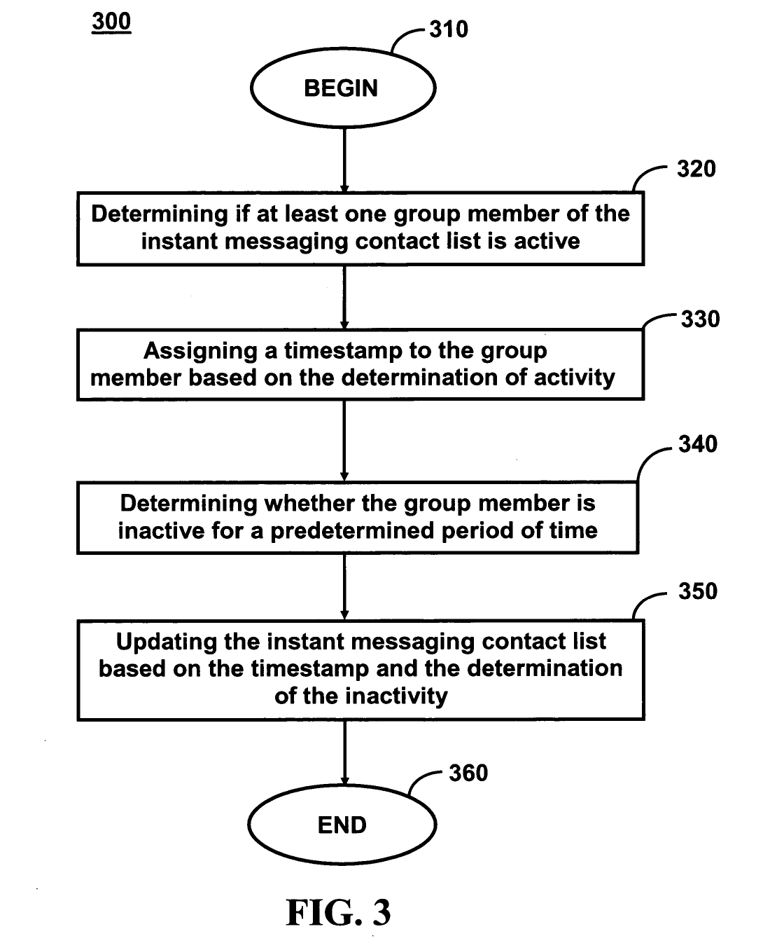

FIG. 3 illustrates a flowchart 300 of one embodiment of a method for managing an IM contact list, in accordance with one embodiment of the present invention Method 300 begins at 310. The present invention can take the form of a computer usable medium including a program for managing an IM contact list in accordance with the present invention The program, stored in the computer usable medium, includes computer program code for executing the method steps described and illustrated in FIG. 2. The program can be stored and executed by the server 110 and/or any of the client computers 120, 122, 124.

The present invention will be described from the viewpoint of a “first user”. First user maintains an IM contact list through client computer 120, but is free to use other computers and make use of first user's IM contact list.

At step 320, the IM program determines if at least one group member is active. In one embodiment, a group member is determined to be active when there is an exchange of information between at least two group members logged on to two computers. For example, if first user participates in a chat or IM session with second user, then second user is considered as active in first user's IM contact list. As used herein, the term ‘chat’ refers to any communication using a network configured for communication between at least two users with limited latency and intended to provide substantially real-time exchange of information, such as an instant messaging network. In another embodiment, if second user is “on-line”, but not exchanging information with first user, second user can still be considered as active in first user's IM contact list. Alternatively, if second user's computer is powered down and without a capability of sending/receiving data, second user is not considered active in first user's IM contact list, in one embodiment.

At step 330, the IM program assigns a timestamp to the group member based on a determination of activity. In one embodiment, upon the determination of a group member being active, the timestamp is issued to the group member. The timestamp can be issued when a group member sends information or an IM to another member, or when a given member maintains an active online connection. As defined herein, an active online connection is a computer that has connected to an IM service, such as a network operating an IM program, for the purpose of sending and receiving data, including instant messages. In this example, second user would receive a timestamp for either chatting with first user or just being on-line. Issuance of a timestamp can be based on a number of other factors, and is not limited to the examples provided herein. The timestamp can apply time according to a calendar, Greenwich Mean Time, or time accessed by systems operating a particular operating system, such as Unix®.

At step 340, the IM program determines whether the group member is inactive for a predetermined period of time. In one embodiment, the timestamp issued to a user is compared to the current time and date. In one embodiment, the timestamp used for the comparison is the latest timestamp issued to a user. In another embodiment, a record is kept tracking each timestamp assigned to a user, and in such embodiments, the latest timestamp is used as the basis for the comparison. For example, first user provides a predetermined period of time (e.g., number of days, weeks, months, and the like), as shown in the IM contact list in FIG. 2. Second user's timestamp is compared with the predetermined period of time. Should a period of inactivity occur between first user and second user meet or exceed the predetermined period of time, then method 300 proceeds to step 350. Otherwise, the method can terminate or revert to a prior step. In the case of third user, however, her timestamp has expired prompting an action such as an IM contact list update.

At step 350, the IM contact list is updated based on the timestamp and the determination of the inactivity. In one embodiment, updating the IM contact list is based on the timestamp, current date and time, and predetermined period of time. In one embodiment, updating the IM contact list is performed automatically. For example, third user is determined to be inactive beyond the predetermined time. As such, IM contact information associated with the third user is automatically (i.e., without user input) removed (e.g., deleted) from the contact list. In another embodiment, updating the IM contact list is performed based on a user prompt. For example, third user is determined to be inactive beyond the predetermined time. A prompt will then appear on first user's screen showing the last time third user was active and would prompt if first user would like third user removed from first user's IM contact list. In one embodiment, the prompt offers an option to revisit the determination at a later time. In such embodiments, the later time may be a standard, predetermined time or a configurable time span. Alternatively, if third user is determined to be inactive beyond the predetermined time, then a prompt would appear on third user's screen showing the last time third user was active and would prompt if third user would like to remain on first user's IM contact list. In one embodiment, third user's IM contact information is archived for later retrieval and removed from first user's IM contact list. Archiving IM contact information comprises removing the contact information from a user's IM contact list, while storing the contact information at a location accessible to the IM contact list for importing after removal. Method 300 terminates at step 360 and is repeated as appropriate.

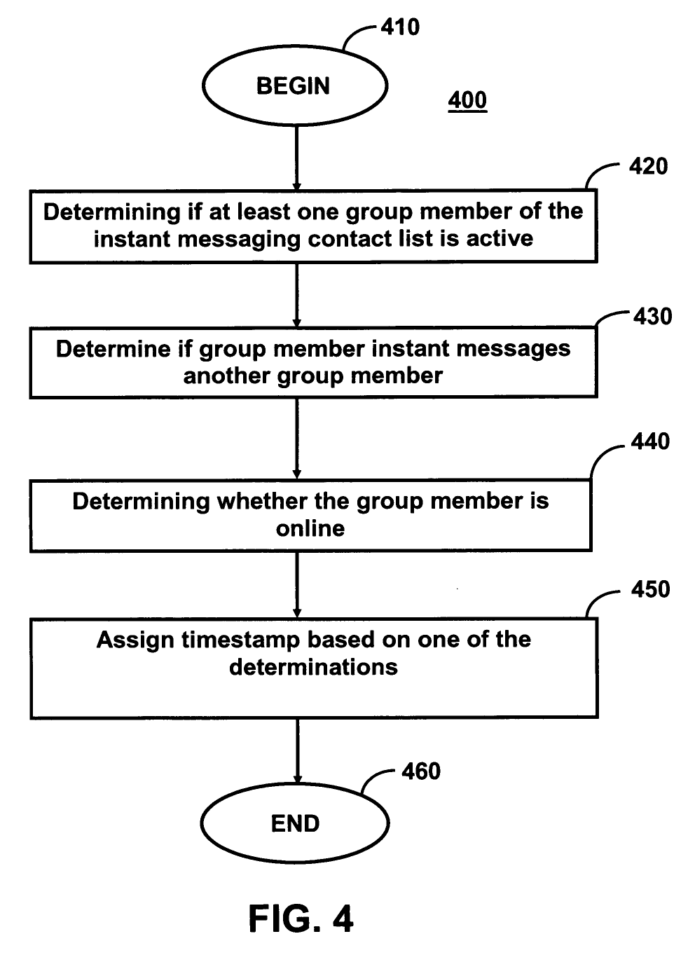

FIG. 4 illustrates one embodiment of a method 400 for assigning a timestamp, in accordance with one aspect of the invention. Method 400 begins at 410. The IM program determines if at least one group member is active at step 420. Determining if the group member is active, in one embodiment, comprises determining if that group member is maintaining an active online connection.

The IM program determines, at step 430, if a group member instant messages another group member. Alternatively, at step 440, the IM program determines whether the group member is online.

At step 450, in response to at least one of the determinations, the IM program assigns a timestamp to the active group member. Assigning a timestamp is implemented as in step 330 in one embodiment. Method 400 ends at 460.

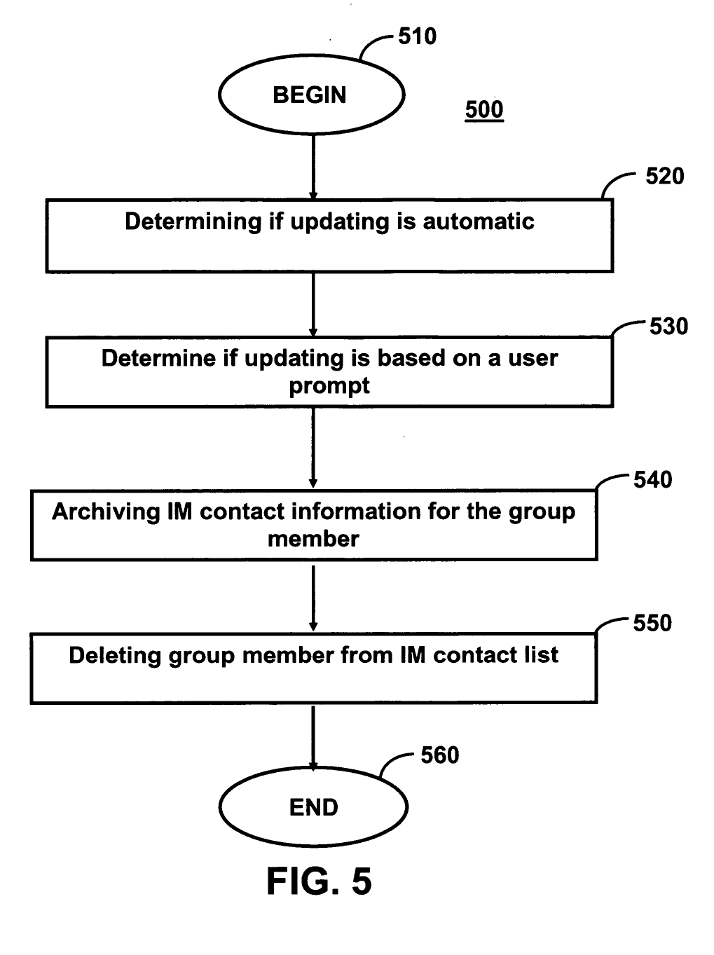

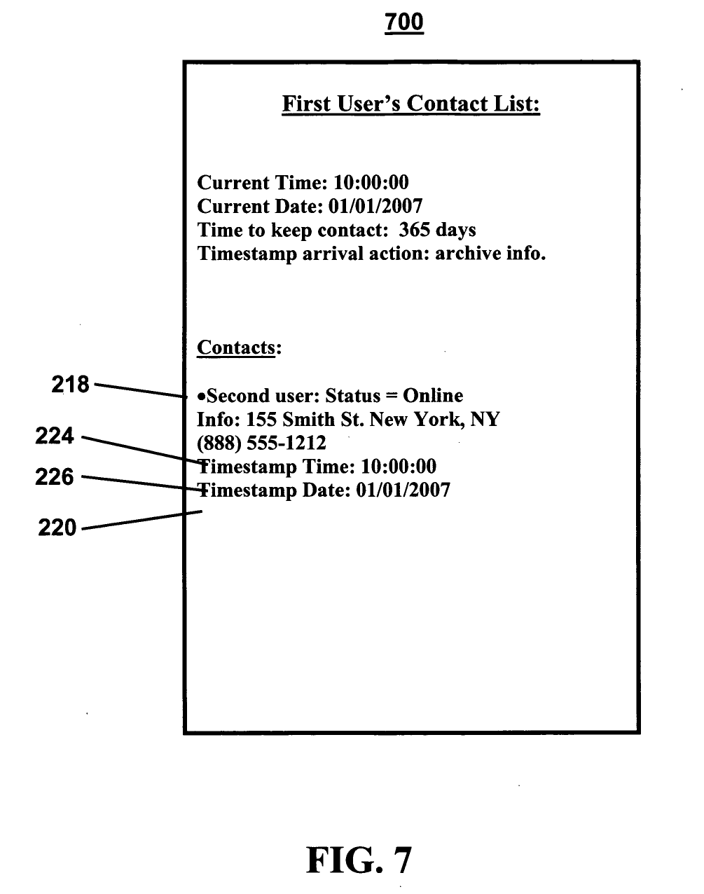

FIG. 5 illustrates one embodiment of a method 500 for updating an IM contact list, in accordance with one aspect of the invention. Method 500 begins at 510. The IM program determines if the IM program is to automatically update IM contact lists at step 520. At step 530, the IM program determines whether the updating of IM contact lists is based on user prompts. In response to one of the determinations, the IM program archives IM contact information for the group member at step 540. In other embodiments, the IM program deletes the group member from the IM contact list at step 550. An example of group member deletion is shown at FIG. 7 at 700, wherein the contact information for third user as illustrated in FIG. 2 above has been removed. Method 500 ends at step 560.

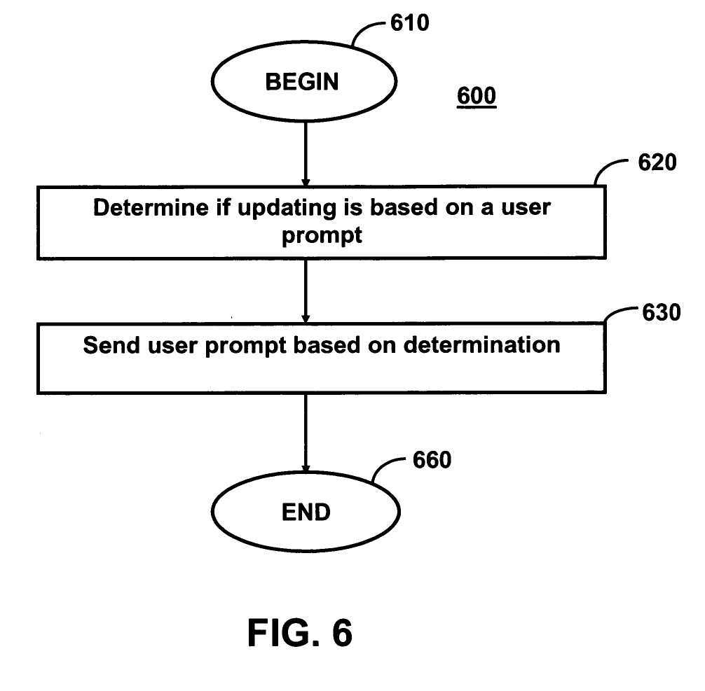

FIG. 6 illustrates one embodiment of a method 600 for updating an IM contact list, in accordance with one aspect of the invention. Method 600 begins at 610. At step 620, method 600 determines if updating IM contact list is based on a user prompt. In response to a positive determination, step 630 sends a user prompt to a user to determine if the IM contact list should be updated. In one embodiment, the prompt offers an option to revisit the determination at a later time. In such embodiments, the later time may be a standard, predetermined time or a configurable time span. Method 600 ends at 660.

It is important to note that the figures and description illustrate specific applications and embodiments of the present invention, and is not intended to limit the scope of the present disclosure or claims to that which is presented therein. While the figures and description present an program run on a server/client computer system, the present invention is not limited to that format, and is therefore applicable to other computer network formats. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of managing an instant messaging contact list, the method comprising:
determining if at least one group member of the instant messaging contact list is active;
assigning a timestamp to the group member based on the determination of activity;
determining whether the group member is inactive for a predetermined period of time; and
updating the instant messaging contact list based on the timestamp and the determination of the inactivity.

2. The method of claim 1 wherein the timestamp is assigned when the group member instant messages another group member.

3. The method of claim 1 wherein the timestamp is assigned when the group member initiates an active online connection.

4. The method of claim 1 wherein the instant messaging contact list comprises instant messaging contact information of the group member.

5. The method of claim 1 wherein updating the instant messaging contact list is performed automatically.

6. The method of claim 1 wherein updating the instant messaging contact list comprises sending a prompt to the group member.

7. The method of claim I wherein updating the instant messaging contact list comprises deleting the group member from the instant messaging contact list.

8. The method of claim 1 wherein updating the instant messaging contact list comprises archiving IM contact information for the group member.

9. A computer usable medium including a program for managing an instant messaging contact list, the medium comprising:
computer readable program code for determining if at least one group member of the instant messaging contact list is active;
computer readable program code for assigning a timestamp to the group member based on the determination of activity;
computer readable program code for determining whether the group member is inactive for a predetermined period of time; and
computer readable program code for updating the instant messaging contact list based on the timestamp and the determination of the inactivity.

10. The computer usable medium of claim 9 wherein the timestamp is assigned when the group member instant messages another group member.

11. The computer usable medium of claim 9 wherein the timestamp is assigned when the group member initiates an active online connection.

12. The computer usable medium of claim 9 wherein the instant messaging contact list comprises contact information of the group member.

13. The computer usable medium of claim 9 wherein updating the instant messaging contact list is performed automatically.

14. The computer usable medium of claim 9 wherein updating the instant messaging contact list is performed based on a user prompt.

15. The computer usable medium of claim 9 wherein updating the instant messaging contact list comprises sending a prompt to the group member.

16. The computer usable medium of claim 9 wherein updating the instant messaging contact list comprises deleting the group member from the instant messaging contact list.

17. The computer usable medium of claim 9 wherein updating the instant messaging contact list comprises archiving IM contact information for the group member.

18. A system of managing an instant messaging contact list, the system comprising:
means for determining if at least one group member of the instant messaging contact list is active;
means for assigning a timestamp to the group member based on the determination of activity;
means for determining whether the group member is inactive for a predetermined period of time; and
means for updating the instant messaging contact list based on the timestamp and the determination of the inactivity.

19. The system of claim 18 further comprising means for storing the timestamp.
